(19) United States
(12) Patent Application Publication
(10) Pub. No.: US 2024/0289832 A1
(43) Pub. Date: Aug. 29, 2024

(54) COUPON CATALOG EXPANSION

(71) Applicant: Microsoft Technology Licensing, LLC, Redmond, WA (US)

(72) Inventors: Bhanu Teja CHUNDURI, Hyderabad (IN); Sandipan MANDAL, West Bengal (IN); Prateek TIWARI, Sammamish, WA (US); Vijayendra Suresh VAIDYA, Hyderabad Telangana (IN); Mohit SHARMA, Jaipur (IN); Nirmal PANT, Haldwani (IN)

(73) Assignee: Microsoft Technology Licensing, LLC, Redmond, WA (US)

(21) Appl. No.: 18/657,231

(22) Filed: May 7, 2024

Related U.S. Application Data
(62) Division of application No. 17/543,284, filed on Dec. 6, 2021.

(51) Int. Cl. G06Q 30/0207; G06F 16/338; G06Q 30/0241

(52) U.S. Cl. CPC G06Q 30/0224; G06F 16/338; G06Q 30/0276

(57) ABSTRACT

The present disclosure relates to systems and methods for a coupon text generation system that generates new coupon text for existing coupons. The systems and methods automatically expand coupon-catalogs using a product class taxonomy hierarchy for merchants that identifies the different products, brands, or product classes for the merchant. The systems and methods create a plurality of new coupon text for a coupon provided by a merchant based on the product class taxonomy for the merchant. The text of the coupon text is rewritten to apply to the different products, brands, and product classes provided by the merchant. The coupons may be ranked, and the top results of the ranked coupons may be returned for presentation on a website.

### CROSS REFERENCE TO RELATED APPLICATIONS

This application is a Divisional of U.S. application Ser. No. 17/543,284, filed Dec. 26, 2021, which is incorporated herein by reference in its entirety.

### BACKGROUND

Majority of the coupons published by merchants on websites are sitewide in nature and applicable for any product within the merchant website. However, search engines or technologies are not able to search the sitewide coupons if users are searching for a specific product class coupon. For example, a user enters a query for “OLED TV coupons” but the coupon corpus has “Up to 85% off on Electronics in Walmart” and “10% OFF on all products in Amazon” as available sitewide coupons. Both available sitewide coupons do not have textual matches with the user-issued query, and thus, the search engines or current technologies miss out on surfacing the available sitewide coupons to offer in response to the user's query for “OLED TV coupons.”

### BRIEF SUMMARY

The present disclosure describes systems and methods for identifying applicable coupons and promotions. For example, in response to a user submitting a search for “dog toy coupons,” the system may identify site-wide coupons (e.g., 10% off all items on the site), category coupons (e.g., 15% off all pet toys), and brand specific coupons (e.g., $10 off all Benbone products). As described in greater detail below, these coupons are identified even when the coupon text does not match the user's query terms. In this way the system is able to present relevant coupons to a user (e.g., ranked according to cost savings) without the user needing to submit multiple queries.

Some implementations relate to a method for automatically generating coupon text. The method may include receiving coupon metadata for a coupon, wherein the coupon metadata identifies a merchant for the coupon and coupon text for the coupon. The method may include obtaining a product class taxonomy for the merchant, wherein the product class taxonomy identifies product information for the merchant. The method may include generating new coupon text for the coupon using the product class taxonomy by rewriting the coupon text based on the product information for the merchant. The method may include storing the new coupon text in a datastore.

Some implementations relate to a method for creating product class taxonomies for merchants. The method may include obtaining browser logs with a plurality of uniform resource locator (URL) impressions. The method may include identifying product URLs for a merchant from the plurality of URL impressions. The method may include mapping the product URLs to products, brands, and product classes. The method may include generating a product class taxonomy for the merchant using the product URLs and the mapping of the product URLs to the products, the brands, and the product classes, wherein the product class taxonomy provides a hierarchy of the product classes, the brands, and the products. The method may include saving the product class taxonomy for the merchant in a datastore.

Some implementations relate to a method for processing new coupon text for a coupon. The method may include receiving a plurality of new coupon text for a coupon. The method may include applying price constraints to the plurality of new coupon text to verify that the plurality of new coupon text is valid. The method may include adding the plurality of new coupon text to a set of generated coupon text based on determining that the new coupon text is valid. The method may include saving the generated coupon text to a datastore.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description which follows, and in part will be obvious from the description, or may be learned by the practice of the teachings herein. Features and advantages of the disclosure may be realized and obtained by means of the instruments and combinations particularly pointed out in the appended claims. Features of the present disclosure will become more fully apparent from the following description and appended claims or may be learned by the practice of the disclosure as set forth hereinafter.

### BRIEF DESCRIPTION OF THE DRAWINGS

In order to describe the manner in which the above-recited and other features of the disclosure can be obtained, a more particular description will be rendered by reference to specific implementations thereof which are illustrated in the appended drawings. For better understanding, the like elements have been designated by like reference numbers throughout the various accompanying figures. While some of the drawings may be schematic or exaggerated representations of concepts, at least some of the drawings may be drawn to scale. Understanding that the drawings depict some example implementations, the implementations will be described and explained with additional specificity and detail through the use of the accompanying drawings in which:

FIG. 1 illustrates an example of current coupons that are presented on a website.

FIG. 2 illustrates an example graphical user interface of a current experience when a user performs a search query for coupons.

FIG. 3 illustrates an example environment for generating coupon text in accordance with implementations of the present disclosure.

FIG. 4 illustrates an example coupon processing model in accordance with implementations of the present disclosure.

FIG. 5 illustrates an example environment for creating a product class taxonomy for merchants in accordance with implementations of the present disclosure.

FIG. 6 illustrates an example generative model in accordance with implementations of the present disclosure.

FIG. 7 illustrates an example environment for presenting generated coupon text in accordance with implementations of the present disclosure.

FIG. 8 illustrates a graphical user interface of a website for performing a query for coupons in accordance with implementations of the present disclosure.

FIG. 9 illustrates an example method for automatically generating coupon text in accordance with implementations of the present disclosure.

FIG. 10 illustrates an example method for creating product class taxonomies for merchants in accordance with implementations of the present disclosure.

FIG. 11 illustrates an example method for processing new coupon text for a coupon in accordance with implementations of the present disclosure.

FIG. 12 illustrates certain components that can be included within a computing system that can be used to implement the actions and operations described herein.

### DETAILED DESCRIPTION

This disclosure generally relates to providing coupons on websites. Majority of the coupons published by merchants for websites are sitewide in nature and applicable for any product within the merchants' website. As such, sitewide coupons are not specific to a brand or category of product and are applicable across the merchant's websites. Non-sitewide coupons are applicable to a certain categories, brands, or products. Merchants generally provide more sitewide coupons on websites as compared to non-sitewide coupons. The coupons have coupon titles that provide information about the discounts (sitewide or non-sitewide) and any constraints that may apply to the coupon. One example constraint includes the coupon code is applicable for students. Another example constraint includes the coupon code is valid if you purchase more than $100. The coupon catalogs that include the coupons for presentation on the websites may include thousands of different coupons (sitewide or non-sitewide) for different providers, merchants, products, and/or brands with various constraints for the coupons.

As an example, a user purchasing a new laptop from a website is given the opportunity to enter coupon codes (also sometimes called discount or promotional codes) at checkout. Rather than having the user open a new browser window or tab to search for coupons, a system of the present disclosure identifies applicable coupon codes and presents them to the user for selection. The system in this example uses machine learning models to extract coupon data and identify applicable site-wide, category, brand, and product coupons. To continue the example scenario, the user may be purchasing a Microsoft Surface laptop. At checkout, the example system identifies applicable site-wide coupons for the website (e.g., free shipping), category coupons (e.g., 10% off all electronics), brand coupons (e.g., $100 off all Microsoft electronics), and product coupons (e.g., 15% off Surface laptops). In a further example, the system ranks the coupons based on an amount of savings for the particular purchase so that the user does not need to manually enter each coupon to check the amount of savings with each. In another example, the system checks whether any coupons may be used in combination and, if so, indicates the combinations to the user. In another example, the system generates new descriptions for the coupons to be more relevant to the user's purchase and/or include additional information for the particular purchase. For example, the category coupon of “10% off all electronics” may be revised to “10%($145) off for your laptop purchase.” In addition, the system pre-categorizes the coupons to be presented faster at runtime.

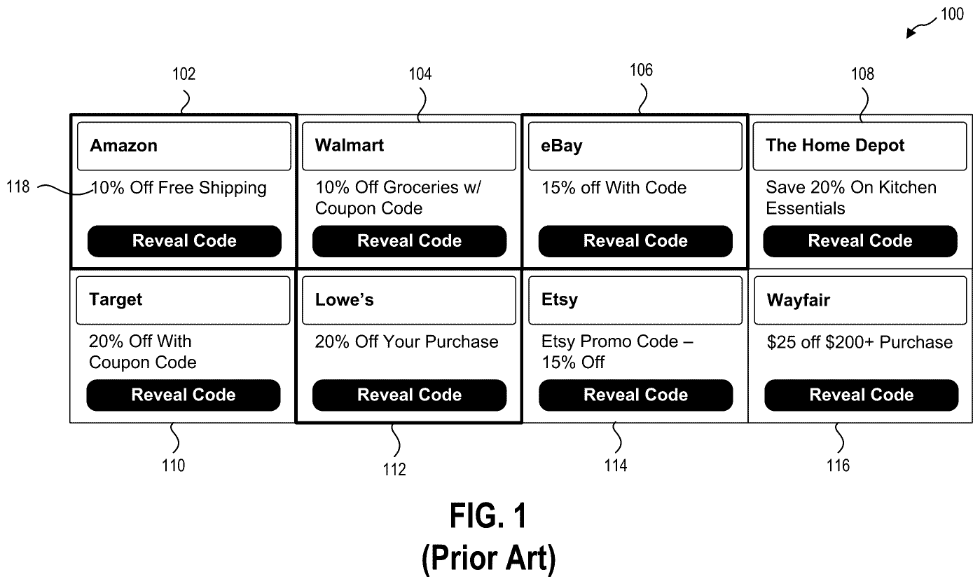

Referring now to FIG. 1, illustrated is a graphical user interface (GUI) 100 of a current experience of a website presenting a plurality of coupons 102, 104, 106, 108, 110, 112, 114, 116. Each coupon 102, 104, 106, 108, 110, 112, 114, 116 identifies the merchant for the coupon. In addition, each coupon 102, 104, 106, 108, 110, 112, 114, 116 has a coupon title that provides information about the discount and any constraints that are applicable to the coupon. As an example, the coupon title 118 provides information about the discount (10% off and free shipping) for the coupon 102 and the constraints (ends in 5 days) that are applicable to the coupon 102. The coupons 102, 106, 112 are examples of sitewide coupons that are not specific to a brand or category of product. The coupon 102 provides 10% off purchases on a merchant's website and free shipping. The coupon 106 provides an extra 10% off with a promo code for purchases on a different merchant's website. The coupon 112 provides 20% off purchases on another merchant's website. As such, a user may use the different sitewide coupons 102, 106, 112 for any products or brands purchased on the corresponding merchant's websites within the constraints provided in the titles of the coupons 102, 106, 112.

The coupons 104, 108, 110, 114, 116 are examples of non-sitewide coupons. Each of the coupons 104, 108, 110, 116 are for a specific brand, product, and/or category of products. The coupon 104 is for a specific category of products (grocery orders) and provides $10 off grocery orders over $50. The coupon 108 is for a specific type of products (select kitchen essentials) and provides 20% on select kitchen essentials. The coupon 110 is for a specific brand of products (Scaraway) and provides 20% off Scaraway Scar Treatment. The coupon 114 is for a specific brand of products (Esty Products). The coupon 116 is for a specific brand of products (professional purchase brand) and provides $25 off $200 of a first professional purchase brand of the merchant. As such, the titles of each of the coupons 104, 108, 110, 116 identifies the specific brands, categories, and/or products the coupons 104, 108, 110, 116 are directed towards and any constraints (minimum purchases, first time purchase) of the coupons 104, 108, 110, 116.

Currently, search engines search the available coupon catalogs (also referred to as the coupon corpus) to identify different coupons to present on websites or coupons to present in response to search queries provided by users. Matching and ranking coupons is challenging because of the lack of contextual information from the coupons and the matching is currently performed by matching key words associated with the coupon. For example, if a user is searching for a shoe coupon using a browser and the coupon catalog has a sitewide coupon for a merchant that sells shoes for “10% off.” The coupon does not have a textual match with the word shoe from the search query, and thus, the search engine is unable to match the available sitewide coupon to the search query and does not present the available coupon in response to the user query. Moreover, when the sitewide coupons are presented to the users on the websites, the sitewide coupons lack contextual coupon titles, making it harder for consumption by users.

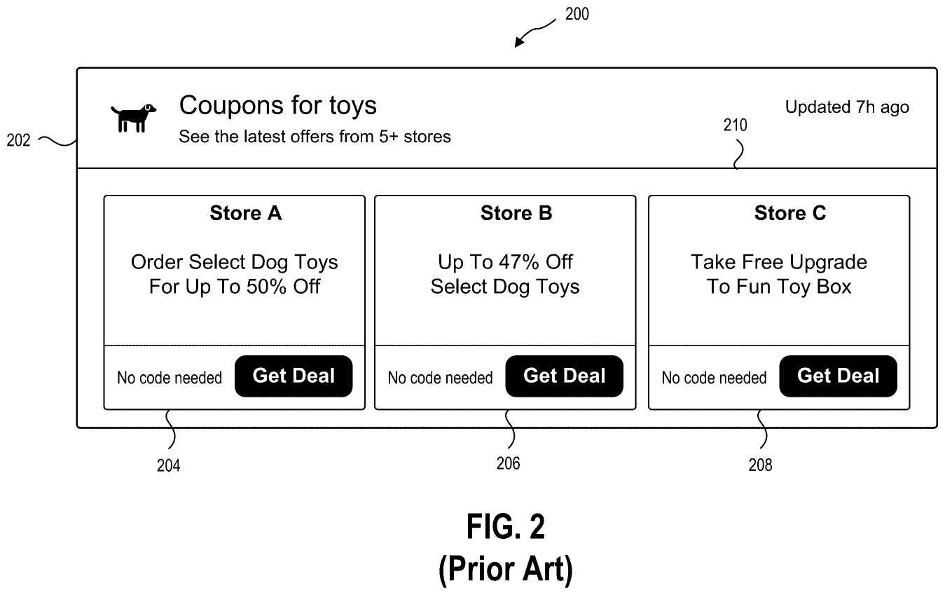

Referring now to FIG. 2, illustrated is an example GUI 200 of a current experience when a user performs a search query 202 for “coupons for toys” on a website. The search engine uses a textual match with words from the search query 202 to match available coupons from the coupon catalog to present on the website in response to the search query 202. Three coupons 204, 206, 208 are presented in response to the search query 202 for “coupons for toys.” Each of the coupons 204, 206, 208 has the word “toy” in the coupon title, which matches the word “toys” from the search query 202. The coupon catalog also has an available sitewide coupon 210 for a toy store that says “15% off” that the search engine does not provide in response to the search query 202 for “coupon toys” since none of the words in the coupon title match words from the search query 202. As such, the user may be unaware of the option for using the sitewide coupon 210 at the toy store.

Thus, if available coupons do not have a textual match with the words from the search queries, search engines are unable to match the available coupons to the search queries and the available coupons are not presented to the users in response to the search queries.

The system of the present disclosure automatically identifies side-wide (general purpose) coupons and links the side-wide coupons to specific queries in accordance with some implementations. A product class taxonomy is created for the merchants in an unsupervised manner, allowing for matching the site-wide coupons to particular products of the merchants. A product class is a granular product category representing a cluster and/or similar type of products. For example, men's t-shirts, kid's wooden toys, women high neck dress, high resolution camera, and/or wireless bluetooth headset. The product class taxonomy is dynamically created for the merchants based on the browser logs. The product class taxonomy provides the product hierarchy chain for the merchant to a granular level for each product class, subcategories of products, brands of products, and product names provided by the merchant.

The system of the present disclosure uses browser logs to create a plurality of new coupon text for a coupon provided by a merchant based on the product class taxonomy for the merchant in accordance with some implementations. The text of the coupon is rewritten to apply to the different products and product classes provided by the merchant. The coupons may be ranked, and the top results may be returned to users in response to a query for a particular product. As such, when a user is searching for a product, the text of the coupon title may be rewritten so that the new coupon title applies to the product included in the search query.

One technical advantage of the present disclosure is saving user interactions (reducing browser instances, clicks, queries, etc.) with the websites and search engines. Having relevant coupons tailored towards the user's context helps increase user engagement with the websites, which in turn results in users returning for coupons. Moreover, having contextual text (e.g., coupon titles, descriptions) for the coupons helps the users to quickly navigate through the coupons and better consume the coupons.

The present disclosure automatically expands the coupon-catalogs using a taxonomy hierarchy for the merchants by generating different text for existing coupons. The auto-expansion of the coupon catalogs is useful in semi-automated coupon article generation as well as in ranking the coupons.

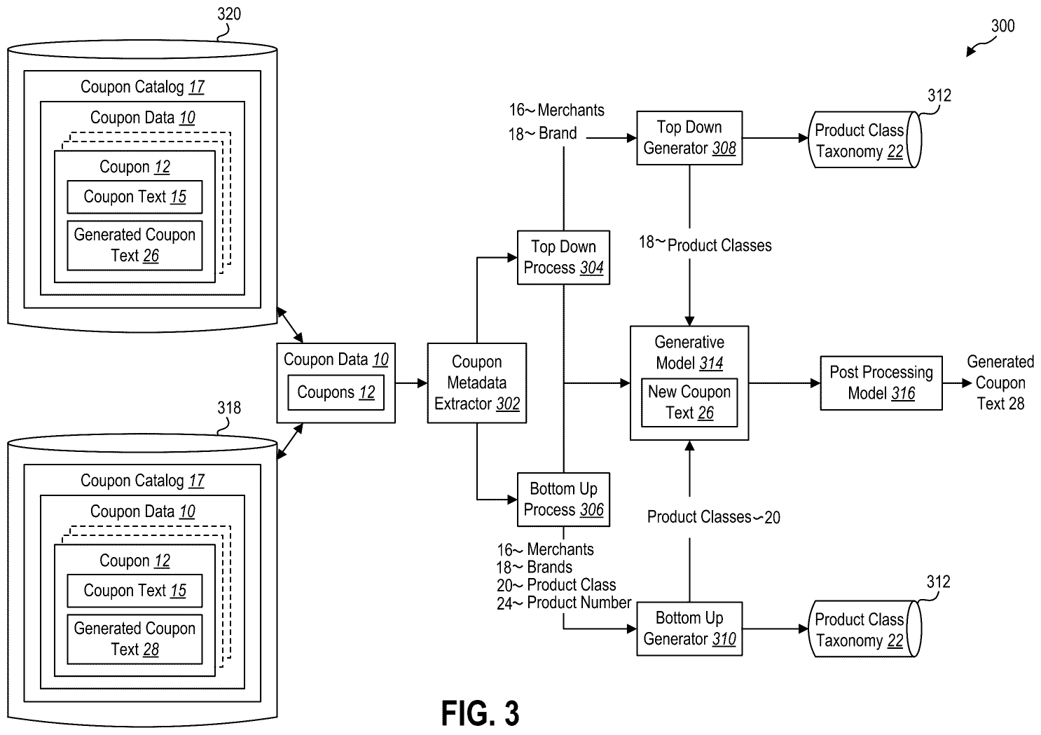

Referring now to FIG. 3, illustrated is an environment 300 for generating coupon text. The environment 300 may include a coupon metadata extractor 302 that obtains coupon data 10 for a plurality of coupons 12 from one or more coupon catalogs 17. The coupon catalogs 17 may be stored in one or more datastores 320, 318 accessible by the coupon metadata extractor 302. In some implementations, the coupon catalogs 17 are from different coupon publishers and the datastore 320 stores the coupon catalog 17 from one coupon publisher and the datastore 318 stores the coupon catalog 17 from a different coupon publisher.

In some implementations, the coupon catalogs 17 contain over two hundred thousand different coupons 12. The coupon metadata extractor 302 parses the coupon data 10 and extracts the coupon metadata 14 for the different coupons 12. The coupon metadata 14 may include, but is not limited to, merchant information, brand information, product information, discount information, and/or constraints for the coupons. The coupon metadata 14 is extracted from the information available in the coupon text 15 for the coupons 12. The coupon text 15 includes, coupon titles, a body of the coupon, information included in the coupon, and/or descriptions included in the coupon. For example, if the coupon text 15 for a coupon 12 includes “10% off with a $50 purchase,” the coupon metadata 14 includes the merchant information, the discount information (10% off), and the constraints (minimum purchase of $50). The coupon metadata extractor 302 uses one or more machine learning models to extract the coupon metadata 14 from the coupons 12.

The coupon metadata 14 may be used to classify whether the coupon 12 is a sitewide coupon or a non-sitewide coupon. Sitewide coupons are not specific to a brand or category of product and are applicable across the merchant's websites. Non-sitewide coupons are applicable to a certain categories, brands, or products. One example includes classifying the coupon 12 as a non-sitewide coupon if the coupon metadata 14 identifies that the coupon 12 is for a specific product name or a specific brand of product. Another example includes classifying the coupon 12 as a sitewide coupon if the coupon metadata 14 identifies a merchant for the coupon 12 without product information or other brand information.

The environment 300 may perform different processing on the coupon metadata 14 based on the information included in the coupon metadata 14 and/or the classification of the coupons 12 (e.g., sitewide coupons or non-sitewide coupons). In some implementations, the environment 300 performs a top down process 304 on the coupon metadata 14 if the coupon metadata 14 only identifies the merchant 16 for the coupon 12 and/or the coupon 12 is classified as a sitewide coupon.

The top down process 304 identifies the merchant 16 and/or the brand 18 information from the coupon metadata 14 and dynamically identifies the classes 20 and subcategories of products associated with the merchant 16. A top down generator 308 maps the merchant 16 with the product classes 20 and/or the product subcategories for the merchant 16 using a product class taxonomy 22 for the merchant 16. The top down generator 308 may obtain the product class taxonomy 22 from a datastore 312 that stores the different product class taxonomies 22 for each merchant 16. In some implementations, the top down generator 308 maps the merchant 16 to popular brands 18 and product classes 20 sold by the merchant 16 using the product class taxonomy 22.

The product class taxonomy 22 identifies the different brands 18 and product classes 20 associated with the merchant 16. For example, if the merchant 16 sells pet supplies, the product class taxonomy 22 includes food, toys, and leashes as the product classes 20 for the merchant 16 and the subcategories include dog food, cat food, chew toys, cat toys, tags, and collars. As such, the top down process 304 identifies the different products and/or subcategories of products for the merchant 16.

In some implementations, the environment 300 performs a bottom up process 306 on the coupon metadata 14 if the coupon 12 is classified as a non-sitewide coupon or the coupon metadata 14 identifies a specific product 24 name, a specific product class 20, or a specific brand 18 in the coupon text 15. The bottom up process 306 takes the specific product 24 name or brand 18 information from the coupon metadata 14 and identifies the merchant 16 associated with the product 24 name or the brand 18. A bottom up generator 310 uses the product class taxonomy 22 for the merchant 16 to cluster the product classes 20 for which the product 24 name, the product class 20, or brand 18 information is applicable. In some implementations, the bottom up generator 310 clusters the product 24 name or brand 18 to a nearest root class or category in the product class taxonomy 22. For example, if the product class 20 is soft toys, the bottom up generator 310 clusters the soft toys product class to a root class of toys. As such, the bottom up generator 310 uses the hierarchical structure of the product class taxonomy 22 for the merchant 16 to broaden the coupon metadata 14 to more general products classes 20.

In some implementations, the environment 300 performs a combination of the top down process 304 and the bottom up process 306 on the coupon metadata 14 based on the information provided in the coupon metadata 14. As such, the environment 300 may generate more specific product classes 20 in addition to more general product classes 20 for the merchant 16 based on the product class taxonomy 22 for the merchant 16.

The environment 300 also includes a generative model 314 that receives the coupon details (e.g., the coupon metadata 14), the brand 18 information, and the product classes 20 generated from the top down process 304 and/or the bottom up process 306. A granular combination of the different product classes 20 and the brands 18 for the merchant 16 are sent to the generative model 314 for processing. The generative model 314 automatically generates the new coupon text 26 for the coupons 12 based on the brand 18 information and the product classes 20 for the merchant 16. The new coupon text 26 rewrite the original coupon text 15 (e.g., the original coupon title) and provide different combinations of the product classes 20 and brands 18 for the merchant 16. In some implementations, the new coupon text 26 includes new coupon titles, new coupon bodies, and/or new descriptions. Thus, instead of having a single coupon title for the coupon 12, the new coupon text 26 provide plurality of new coupon titles with specific product classes 20 and/or brands 18 for the coupon 12.

One example use case includes a sitewide coupon for “10% off” for a merchant 16 that sells children's toys. One new coupon title generated for the new coupon text 26 is “10% off toy cars.” Another new coupon title generated for the new coupon text 26 is “10% off STEM toys.” In addition, another new coupon title generated for the new coupon text 26 is “10% off building blocks.” Another new coupon title generated for the new coupon text 26 is “10% off board games.” Thus, the coupon text 15 (10% off) for the sitewide coupon is rewritten to include specific products and/or categories of products provided by the merchant 16.

Another example use case includes a coupon 12 for “20% off a specific brand of dog food” sold by a merchant 16. A new coupon text 26 is generated for “20% off dog food.” Another new coupon text 26 is generated for “20% off pet food.” As such, the coupon text 15 for a non-sitewide coupon is broaden out to more general classes and/or categories of products provided by the merchant 16.

The generative model 314 expands the original coupon text 15 for the coupon 12 using various combinations of product classes 20 and/or brands 18 identified for the merchant 16. In some implementations, the generative model 314 generates hundreds of different new coupon text 26 for the coupon 12. The new coupon text 26 may have different hierarchical levels based on the product class taxonomy 22 identified for the merchant 16.

In some implementations, the generative model 314 is a rule based system that generates the new coupon text 26 based on one or more rules. In some implementations, the generative model 314 is a machine learning model that is trained to generate the new coupon text 26.

A post processing model 316 may perform one or more pruning steps on the new coupon text 26 to reduce the new coupon text 26 to a subset of generated coupon text 28. The pruning steps may remove incorrect coupon titles from the new coupon text 26. In addition, the pruning steps may verify that the new coupon text 26 is applicable to the products.

In some implementations, the post processing model 316 applies price constraints based on the average prices, the minimum prices, and/or the maximum prices of the products in a specific product class for the merchant 16 using the information from the product class taxonomy 22 for the merchant 16 to ensure that the new coupon text 26 is applicable to the products. The post processing model 316 may apply the new coupon text 26 on a sample set of products for the merchant 16. In some implementations, auto apply feature logs apply the new coupon text 26 to the sample set of products and verify if the new coupon text 26 is valid. If the new coupon text 26 is applicable to the sample set of products, the new coupon text 26 is added to the generated coupon text 28 subset. If the new coupon text 26 is not applicable to the sample set of products, the new coupon text 26 is not added to the generated coupon text 28 subset. In some implementations, the generated coupon text 28 includes a new coupon titles, a new coupon bodies, and/or a new descriptions.

One example use case includes a coupon text 15 of “10% off on all products on a merchant's website up to $50” for a coupon 12. A new coupon text 26 is generated that includes “10% off on a specific brand of chew toys up to $5.” The post processing model 316 applies a price constraint based on the average price information available for the specific brand of chew toys using the product class taxonomy 22 and determines that the specific brand of chew toys cost more than $5. As such, the post processing models 316 removes the new coupon text 26 “10% off on a specific brand of chew toys up to $5” from the generated coupon text 28 based on determining that the new coupon text 26 is not applicable to the pricing for the specific brand of chew toys.

Another example use case includes a coupon text 15 of “$50 off on all products on a merchant's website” for a coupon 12. A new coupon text 26 is generated that includes “$50 off on a specific brand of dog food.” The post processing model 316 applies a price constraint based on the average price information available for the specific brand of dog food using the product class taxonomy 22 and determines that the specific brand of dog food cost more than $50. The post processing model 316 keeps the new coupon text 26 based on determining that the new coupon text 26 is applicable to the pricing for the specific brand of dog food.

By removing the new coupon text 26 that is incorrect or not applicable to the product class, the post processing model 316 reduces the generated coupon text 28 to valid coupons for the products and prevents misrepresentations of the generated coupon text 28 for the products.

In some implementations, the post processing model 316 receives information that the new coupon text 26 is applicable to the product class. The information is received from browser logs that identify coupon tags users clicked on when searching for products. The browser logs identify if a particular coupon is applied to a specific type of product and whether the coupon works for the specific type of product. The information may be used by the post processing model 316 to avoid a large number of restrictions and prune out incorrect new coupon text 26 based on the information.

The post processing model 316 may reduce the number of new coupon text 26 to the generated coupon text 28 and provide a high confidence dataset with the generated coupon text 28. The amount of post processing may vary based on a level of confidence for the generated coupon text 28. For example, for a high confidence dataset, a large sample set of products are tested using the new coupon text 26 for price constraints and the additional processing occurs using the browser logs. For a lower confidence dataset, a smaller sample set of products are tested using the new coupon text 26 for price constraints and the additional processing using the browser logs is skipped.

The generated coupon text 28 is added to the coupon catalogs 17 databases and associated with the original coupon 12. For example, a coupon identification (ID) for the original coupon 12 is associated with the generated coupon text 28. Thus, instead of having a single coupon title for the coupon 12, the coupon catalog 17 has a plurality of generated coupon titles for the coupon 12. In some implementations, the coupon catalog 17 is expanded from an original corpus size of two hundred thousand coupons with the original coupon titles to an expanded corpus size of eight hundred thousand coupons with the generated coupon text 28 (e.g., generated coupon titles). The generated coupon text 28 may provide more contextual information for the coupon 12 by adding in specific product names 24, product classes 20, and/or brands 18. Different applications (e.g., coupon publishing platforms) or search engines may obtain the generated coupon text 28 from the coupon catalogs 17 and present the generated coupon text 28 on a website.

The environment 300 may have multiple machine learning models (e.g., the coupon metadata extractor 302, the top down generator 308, the bottom up generator 310, the generative model 314, and/or the prost processing model 316) running simultaneously. In some implementations, one or more computing devices are used to perform the processing of environment 300. The one or more computing devices may include, but are not limited to, server devices, personal computers, a mobile device, such as, a mobile telephone, a smartphone, a PDA, a tablet, or a laptop, and/or a non-mobile device. The features and functionalities discussed herein in connection with the various systems may be implemented on one computing device or across multiple computing devices. For example, the coupon metadata extractor 302, the top down generator 308, the bottom up generator 310, the generative model 314, the post processing model 316, and/or the datastores 312, 320, 318 are implemented wholly on the same computing device. Another example includes one or more subcomponents of the coupon metadata extractor 302, the top down generator 308, the bottom up generator 310, the generative model 314, the post processing model 316, and/or the datastores 312, 320, 318 implemented across multiple computing devices. Moreover, in some implementations, the coupon metadata extractor 302, the top down generator 308, the bottom up generator 310, the generative model 314, the post processing model 316, and/or the datastores 312, 320, 318 are implemented or processed on different server devices of the same or different cloud computing networks. Moreover, in some implementations, the features and functionalities are implemented or processed on different server devices of the same or different cloud computing networks.

In some implementations, each of the components of the environment 300 is in communication with each other using any suitable communication technologies. In addition, while the components of the environment 300 are shown to be separate, any of the components or subcomponents may be combined into fewer components, such as into a single component, or divided into more components as may serve a particular implementation. In some implementations, the components of the environment 300 include hardware, software, or both. For example, the components of the environment 300 may include one or more instructions stored on a computer-readable storage medium and executable by processors of one or more computing devices. When executed by the one or more processors, the computer-executable instructions of one or more computing devices can perform one or more methods described herein. In some implementations, the components of the environment 300 include hardware, such as a special purpose processing device to perform a certain function or group of functions. In some implementations, the components of the environment 300 include a combination of computer-executable instructions and hardware.

The processing of the environment 300 may occur on a periodic basis. The coupon metadata extractor 302 obtains the coupon data 10 within a given cadence and the generative model 314 may automatically generate the new coupon text 26 for the coupon data 10 to upload to the coupon catalogs 17. One example includes the generative model 314 generating the new coupon text 26 on a daily basis (e.g., generating new coupon titles daily). Another example includes the generative model 314 generating the new coupon text 26 for any new coupons 12. The new coupon text 26 may be generated before ingesting the new coupons 12 into the coupon catalogs 17. Moreover, as the coupons 12 expire, the coupons 12 and the associated new coupon text 26 are removed from the coupon catalogs 17 to ensure that coupon catalogs 17 maintain current coupons. For example, the expired coupon 12 is identified and the coupon ID for the expired coupon 12 is used to identify the new coupon text 26 associated with the expired coupon 12 to remove from the coupon catalogs 17. As such, the environment 300 may automatically expand the coupon catalogs 17 with contextually rich new coupon text 26 for the different merchants 16.

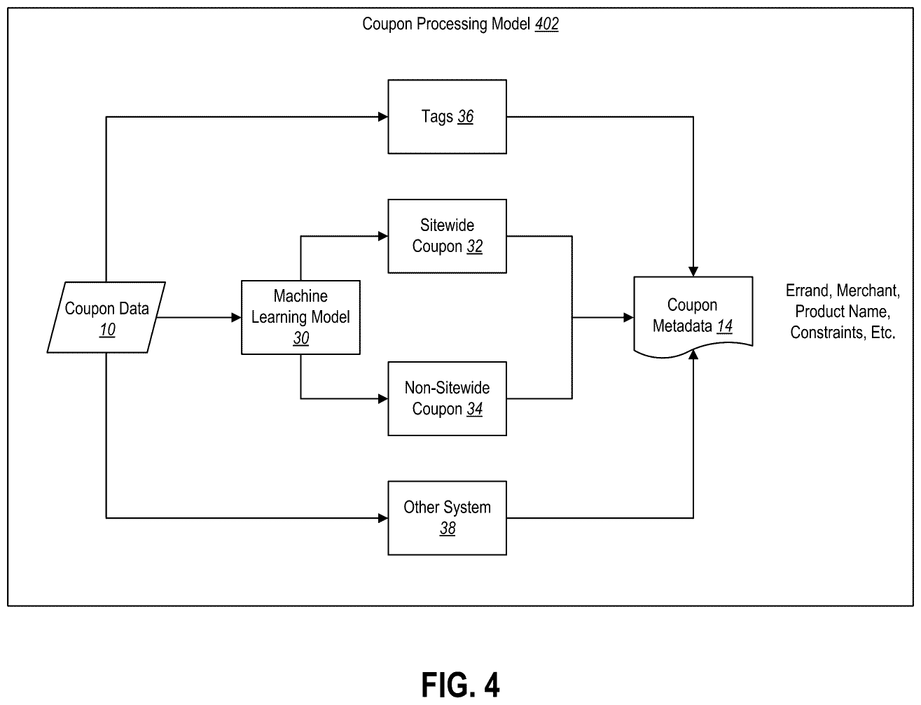

Referring now to FIG. 4, illustrated is an example coupon processing model 402 for use with some implementations. The coupon processing model 402 obtains the coupon data 10 for a plurality of coupons 12 (FIG. 3) that are presented on different websites. In some implementations, the coupon data 10 is obtained from the coupon catalog 17 (FIG. 3) databases that store the plurality of coupons 12 for the different websites. In some implementations, the coupon data 10 is obtained from crawling different merchant's websites and identifying any deals or coupons on the merchant's websites. In some implementations, the coupon data 10 is obtained from third party partners that publish coupons. As such, the coupon data 10 may be obtained from a plurality of sources or publishers of coupons 12.

The coupon processing model 402 may parse the coupon information to extract various components to identify the merchant, the brand, the product class, savings quantifiers, and/or any constraints for the coupon 12. In some implementations, the coupon processing model 402 parses the coupon text 15 (FIG. 3) (e.g., the coupon titles, descriptions included in the coupon, information included in the coupon, and/or the body of the coupons) and uses the information from the coupon titles to identify the merchant, the brand, the product class, savings quantifiers, and/or any constraints for the coupon 12.

In some implementations, the coupon processing model 402 identifies any tags 36 associated with the coupon data 10 and obtains the information about the coupons 12 from the tags 36. In some implementations, the coupon processing model 402 also accesses other systems 38 for obtaining information about the coupons 12.

The coupon processing model 402 may include one or more machine learning models 30 that classifies the different coupons 12 into a sitewide coupon 32 or a non-sitewide coupon 34. The sitewide coupons 32 are not specific to a brand or category of product and are applicable across the merchant's websites. The non-sitewide coupons 34 are applicable to a certain categories, brands, or products.

In some implementations, the machine learning model 30 parses the coupon data 10 to identify the coupon text 15 and uses the information from the coupon text 15 in classifying the coupons 12 as sitewide coupons 32 or non-sitewide coupons 34. For example, if the coupon text 15 includes a product name or brand information, the machine learning model 30 classifies the coupon 12 as a non-sitewide coupon 34. If the coupon text 15 does not include any product information or brand information, the machine learning model 30 classifies the coupon 12 as a sitewide coupon 32.

The coupon processing model 402 may generate the coupon metadata 14 based on the information extracted from the coupon text 15, the information obtained from the tags 36, and/or the information obtained from the other systems 38. The coupon metadata 14 may include the merchant, the brand information, a product name, constraints for the coupon, the information received from the other systems 38, and/or the information received from the tags 36. The coupon metadata 14 may also include the sitewide coupon 32 or non-sitewide coupon 34 classification for the coupon 12. In some implementations, the coupon metadata extractor 302 (FIG. 3) uses the coupon metadata 14 generated by the coupon processing model 402. In some implementations, the generator model 314 (FIG. 3) uses the coupon metadata 14 generated by the coupon processing model 402 in creating the new coupon text 26.

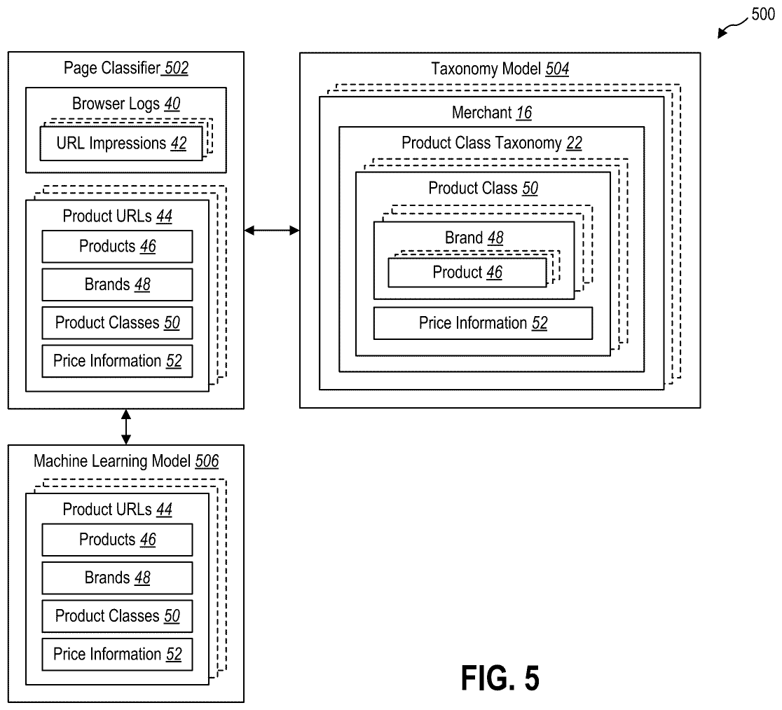

Referring now to FIG. 5, illustrated is an example environment 500 for generating the product class taxonomy 22 for the merchants 16 (FIG. 1). The environment 500 dynamically creates the product class taxonomy 22 for any merchant 16 using browser logs 40. The product class taxonomy 22 provides the product hierarchy of the different products 46 that the merchant 16 provides or sells. The product class taxonomy 22 may include different product classes 50 and subcategories of products provided by the merchant 16. A product class is defined as a granular product category representing a cluster and/or similar type of products. For example, men's t-shirts, kid's wooden toys, women high neck dress, high resolution camera, wireless bluetooth headset etc. As such, the product class taxonomy 22 provides a hierarchical chain of the different products 46 that the merchant 16 provides with the product class 50 at the root of the chain with the subcategories at a next level followed by the different products 46 and/or brands 48 of products 46.

The environment 500 includes a page classifier 502 that obtains the browser logs 40 with a plurality of uniform resource locator (URL) impressions 42. The URL impressions 42 include the different websites visited by one or more users interacting with one or more browsers. The browsers allow the users to interact with information on the World Wide Web. When a user requests a webpage from a website by performing a search using the browser or entering in a URL of a website using the browser, the URL impressions 42 are recorded in the browser logs 40. As such, the browser logs 40 capture the URL impressions 42 from a plurality of users worldwide using a variety of devices and/or a variety of browsers to access different websites. The product page classifier 502 obtains the browser logs 40 with the URL impressions 42 on a regular basis. One example includes the product page classifier 502 obtaining the browser logs 40 for the past six months. By obtaining the browser logs 40 on a regular basis, the dynamic discovery of the taxonomy of the merchant 16 improves as the products are sold by the merchant 16 and/or users' engagement with the merchant's 16 webpages changes.

The product page classifier 502 mines all the URL impressions 42 viewed by the users and classifies the product URLs 44 for different merchants 16 from the URL impressions 42. The product page classifier 502 identifies the URL as a product description page (e.g., a product URL 44) or not a product description page from a merchant's 16 website. A machine learning model 506 in communication with the product page classifier 502 extracts the product 46 title, description, image, brand 48, and/or price information 52 from the product URL 44. An offer categorizer uses the information extracted from the product URL 44 by the machine learning model 506 to classify the products 46 to one of the product classes 50. As such, each of the product URLs 44 are mapped to different products 46, brands 48 and product classes 50. The product page classifier 502 uses the browser logs 40 to identify the different products 46 viewed by users when interacting with the browsers.

In some implementations, the page classifier 502 uses one or more machine learning models 506 to match the URLs with a product catalog for the browser. The product catalog may be predefined When a match occurs between the URL and a product, the URL impression 42 is identified as a product URL 44. In addition, the machine learning models 506 may extract the products 46, brands 48, and/or product classes 50 from the websites associated with the product URL 44.

In some implementations, the machine learning models 506 are trained for instance based learning per domain to understand different product websites per merchant. The machine learning models may be trained to extract the title of the products, pricing of the products and other information of the products from the product URLs 44 (e.g., the product websites of the merchant 16) and classify the products into a known product class category.

The machine learning model 506 uses the product URLs 44 to extract additional information. For each product URL 44, the machine learning model 506 extracts the product 46 title, the price information 52 and the brand 48 information. In some implementations, the price information 52 includes an average price for the products 46 and/or the brands 48. In some implementations, the price information 52 includes a minimum price and/or a maximum price for the products 46 and/or the brands 48.

A taxonomy model 504 generates the product class taxonomy 22 for the merchant 16 using the product URLs 44 and the product class 50, brands 48, and product 46 information extracted from the product URLs 44. In some implementations, the product class taxonomy 22 is based on an impression count of the product URLs 44 for websites for the product classes 50, the brands 48, and the products 46. A threshold value may be set for the impression counts and the product classes 50, the brands 48, and the products 46 with impression counts that exceed the threshold value are included in generating the product class taxonomy 22. The product classes 50, the brands 48, and the products 46 with impression counts below the threshold level are not included in the product class taxonomy 22. As such, popular products 46 and brands 48 (products and brands where the impression counts exceed the threshold value and indicate more users viewed the products and brands) may be included in the product class taxonomy 22 instead of less popular products (products and brands where the impression counts are below are the threshold level and indicate fewer users viewed the products and brands). A subset of the products classes 50, the brands 48, and the products 46 of a merchant 16 may be included in the product class taxonomy 22 based on the impression counts of the product URLs 44.

In some implementations, the taxonomy model 504 normalizes different names for the same brand 48 into a single name for the brand 48 to prevent duplication in the product class taxonomy 22. For example, the brand “Microsoft” and “Microsoft Inc.” is mapped to the brand “Microsoft” to reduce the entries in the product class taxonomy 22 for the brand 48 from two different entries to a single entry.

The product class taxonomy 22 may also include the price information 52. The price information 52 provides for every merchant 16, a price range for all the products 46 sold. If the merchant 16 has different product classes 50, the price information 52 provides for each product class 50, within the brands 48 for the product classes 50, a minimum and maximum price for the products 46 sold. The price information 52 may also include an average price of the products 46 sold by the merchant 16.

In some implementations, the product page classifier 502 uses the browser logs 40 from a specific timeframe to create the product class taxonomy 22. One example timeframe is the past six months. As such, the product class taxonomy 22 is dynamically created based on recent user interactions with the merchant's websites using the URL impressions 42 from the past six months. By continually updating the product class taxonomy 22 for the merchant 16, new products may be captured in the updated product class taxonomy 22. In addition, as different products gain or lose popularity, the product class taxonomy 22 is updated to reflect the changes in user preferences of the products.

The taxonomy model 504 generates the product class taxonomy 22 for each merchant 16. As such, different merchants 16 have a specific product class taxonomy 22 based on the product URLs 44 for the merchant 16.

An example algorithm used by the taxonomy model 504 to generate the product class taxonomy 22 includes:
(1) For all Mi-{Pi, Bi};
(2) Map<Pij, <Bik, Avg(price), Max(price), Min(Price)>>associations,
   where Pi is the product taxonomy specific to the merchant 16 and Bi is the brand set the merchant 16 is selling. Pij represents the granular product class and Bik represents the granular brand sold by the merchant 16 for that product class. The Avg (price) is the average price, the Max(price) is the maximum price, and the Min(Price) is the minimum prices for all products 46 for each brand 48 and product class 50 association.

As such, the taxonomy model 504 generates for each merchant 16, a granular mapping of the average prices, a minimum price, and a maximum price for all the products 46 sold by the merchant 16. In addition, the product class taxonomy 22 allows for matching sitewide coupons 32 (FIG. 4) to particular products 46 by the merchant 16.

The environment 500 may have multiple machine learning models running simultaneously. In some implementations, one or more computing devices are used to perform the processing of environment 500. The one or more computing devices may include, but are not limited to, server devices, personal computers, a mobile device, such as, a mobile telephone, a smartphone, a PDA, a tablet, or a laptop, and/or a non-mobile device. The features and functionalities discussed herein in connection with the various systems may be implemented on one computing device or across multiple computing devices. For example, the page classifier 502 and/or the taxonomy model 504 are implemented wholly on the same computing device. Another example includes one or more subcomponents of the page classifier 502 and/or the taxonomy model 504 implemented across multiple computing devices. Moreover, in some implementations, the page classifier 502 and/or the taxonomy model 504 are implemented or processed on different server devices of the same or different cloud computing networks. Moreover, in some implementations, the features and functionalities are implemented or processed on different server devices of the same or different cloud computing networks.

In some implementations, each of the components of the environment 500 is in communication with each other using any suitable communication technologies. In addition, while the components of the environment 500 are shown to be separate, any of the components or subcomponents may be combined into fewer components, such as into a single component, or divided into more components as may serve a particular implementation. In some implementations, the components of the environment 500 include hardware, software, or both. For example, the components of the environment 500 may include one or more instructions stored on a computer-readable storage medium and executable by processors of one or more computing devices. When executed by the one or more processors, the computer-executable instructions of one or more computing devices can perform one or more methods described herein. In some implementations, the components of the environment 500 include hardware, such as a special purpose processing device to perform a certain function or group of functions. In some implementations, the components of the environment 500 include a combination of computer-executable instructions and hardware.

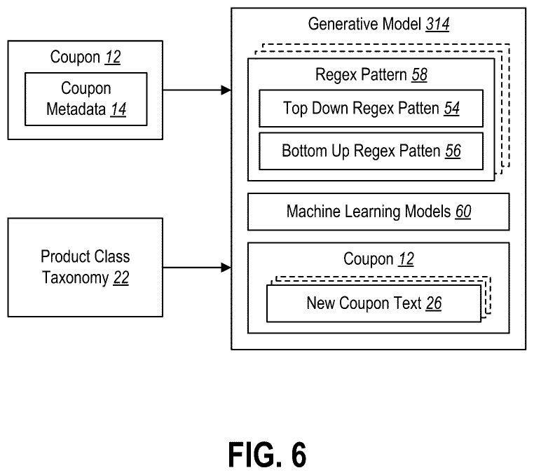

Referring now to FIG. 6, illustrated is a generative model 314 for use with some implementations. The generative model 314 receives the processed coupon corpus (the coupon metadata 14) and the product class taxonomy 22 for the merchant 16 and outputs the new set of coupon text 26 for the coupons 12. In some implementations, the new coupon text 26 includes new coupon titles, new coupon bodies, and/or a new descriptions.

In some implementations, the generative model 314 uses regex patterns 58 with placeholders to fill in for a new coupon text 26 for the coupon 12. The regex patterns 58 may have different placeholders (savings quantifier, constraints, the product class, and products) corresponding to the different portions of the new coupon text 26 for the coupon 12 that the generative model 314 fills in based on the information received in the product class taxonomy 22 and/or the coupon metadata 14. In some implementations, the regex patterns 58 includes a top down regex pattern 54 or a bottom up regex pattern 56.

The regex patterns 58 selected for the new coupon text 26 may be based on the coupon metadata 14 and the classification of the coupon 12. For example, the top down regex pattern 54 is selected if the coupon 12 is classified as a sitewide coupon 32 (FIG. 4) and the bottom up regex pattern 56 is selected if the coupon 12 is classified as a non-sitewide coupon 34 (FIG. 4).

The generative model 314 adds information from the information from the coupon metadata 14 and the product class taxonomy 22 for the merchant 16 into the different placeholders (savings quantifier, constraints, the product class, and products) for the regex patterns 58.

An example of a top down regex pattern 54 includes: <Upto>““<Savings quantifier>” On “<Bik Belonging to Pij><constraints>“ ”<Pij>, where Pij is the granular product class and Bik is the granular brand sold by the merchant for that product class. The generative model 314 identifies the savings quantifier and the constraints from the coupon metadata 14 and fills in the savings quantifier placeholder and the constraints placeholder with the information from the coupon metadata 14. The generative model 314 identifies the product class from the product class taxonomy 22 and fills in the product class placeholder with the information from the product class taxonomy 22. One example use case includes a coupon 12 with a coupon title “10% off sitewide at a pet merchant's website.” An example written regex pattern 58 using the top down regex pattern 54 for the coupon 12 includes Upto 10% off on a specific brand of Chew Toys.

An example of a bottom up regex pattern 56 includes: <Upto>” “<Savings quantifier>” On” <Pij><constraints>, where Pij is the granular product class. The generative model 314 identifies the savings quantifier and the constraints from the coupon metadata 14 and fills in the savings quantifier placeholder and the constraints placeholder with the information from the coupon metadata 14. The generative model 314 identifies the product class from the product class taxonomy 22 and fills in the product class placeholder with the information from the product class taxonomy 22. One example use case includes a coupon 12 with a coupon title “10% off on a specific brand of toys at a pet merchant's website.” An example written regex pattern 58 using the bottom up regex pattern 56 includes Upto 10% off on Chew Toys.

The generative model 314 uses one or more machine learning models 60 to scale the number of regex patterns 58 to write for the coupon 12. The machine learning models 60 identify the different variations present for the regex patterns 58 based on the products, brands, and product classes included in the training data. The machine learning models 60 dynamically generate the coupon text for the different combinations of the products, brands, and product classes with the information from the coupon metadata 14 and the product class taxonomy 22. In some implementations, the machine learning models 60 are deep learning based generative models.

The text of the coupon 12 is rewritten using the regex patterns 58 to apply the different products 46 (FIG. 5), brands 48 (FIG. 5), and/or product classes 50 (FIG. 5) that the product class taxonomy 22 indicates that the merchant 16 provides. Each regex pattern 58 written corresponds to a new coupon text 26. The new set of coupon text 26 for the coupons 12 are used to generate the expanded version of the coupon corpus.

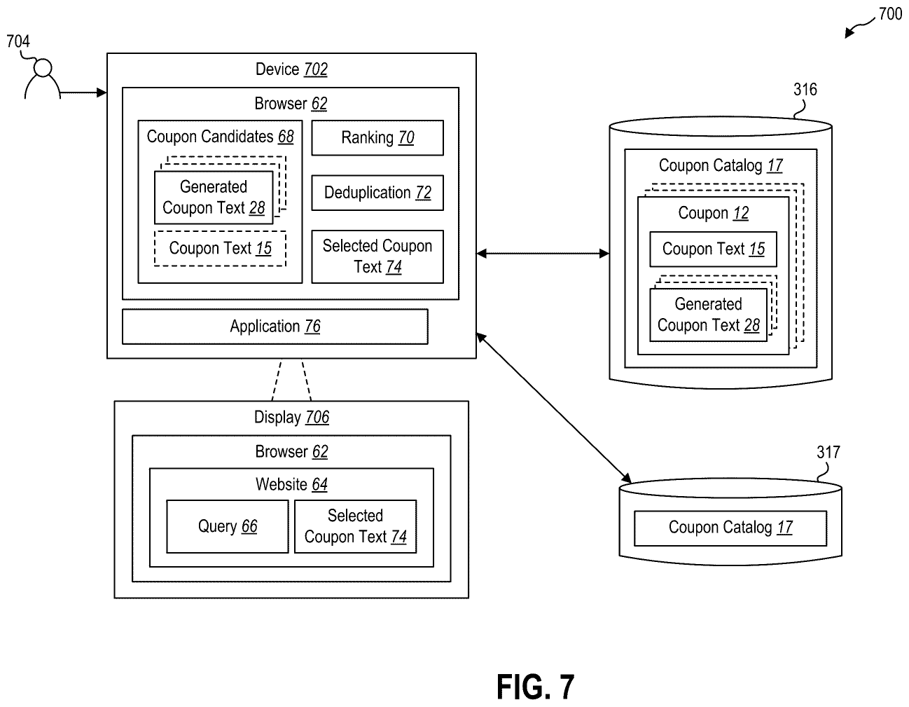

Referring now to FIG. 7, illustrated is an example environment 700 for presenting the generated coupon text 28. The environment 700 may include one or more users 704 interacting with one or more devices 702. The devices 702 may include one or more browsers 62 that allow the users 704 to interact with information on the World Wide Web. When a user 704 requests a website 64 (by performing a search using the browser 62 or entering in a uniform resource locator (URL) of the website 64 using the browser 62), the browser 62 retrieves the content of the website 64 from a webserver and displays the website 64 on a display 706 associated with the user's device 702. The website 64 may present any webpage (third party webpages or webpages from the same party that provides the browser 62). In addition, the browser 62 may be a browser application on a device 702 of the user 704. Examples of browsers 62 include, but are not limited to, EDGE™ and INTERNET EXPLORER™.

In some implementations, the user 704 enters in a query 66 with search terms. Example queries 66 include searching for a product, searching for a merchant, searching for a specific brand, and/or exploratory searching. The browser 62 access one or more coupon catalogs 17 stored in datastores 320, 318 and retrieves coupon candidates 68 for presentation on the website 64 in response to the query 66.

The coupon candidates 68 may include a coupon text 15 and/or a plurality of generated coupon text 28 from the coupon catalog 17. The coupon candidates 68 are obtained based on a match between the search terms from the query 66 and the terms in the coupon text 15 and/or the generated coupon text 28.

In some implementations, the browser 62 applies a ranking 70 on the coupon candidates 68 to generate scores for the coupon candidates 68 and place the coupon candidates 68 in an order based on the scores. For example, the order is a descending order with higher scores placed first. In some implementations, the ranking 70 is performed by one or more machine learning models that determines the score based on how many words match between the search terms from the query 66 and the terms in the coupon text 15 and/or the generated coupon text 28. A complete match of terms (e.g., all of the terms match between the search terms from the query 66 and the terms in the coupon text 15 and/or the generated coupon text 28) may have a higher score relative to a partial match of terms (e.g., a portion of the terms match between the search terms from the query 66 and the terms in the coupon text 15 and/or the generated coupon text 28).

In some implementations, the ranking 70 is based on a popularity of the merchant 16 (FIG. 3). The popularity of the merchant 16 may be based on a number of URL impressions received for the merchant 16. In some implementations, the score is based on a combination of the popularity of the merchant 16 and the matching of the terms from the query 66 and the terms from the coupon text 15 and/or the generated coupon text 28.

The browser 62 may select coupon text 74 from the coupon candidates 68 to present on the websites 64. The selected coupon text 74 may be a subset of the coupon candidates 68 based on the ranking 70. For example, the selected coupon text 74 are a top portion of the ranked list of coupon candidates 68 (e.g., the top ten coupons).

The browser 62 may perform a deduplication 72 of the coupon candidates 68 and select a portion of the coupon candidate 68 per coupon code. One example includes selecting one coupon candidate 68 per coupon code. If the coupon 12 has thirty generated coupon text 28 returned as a coupon candidates 68 for the query 66, the deduplication 72 may pick one coupon candidate 68 from the two hundred coupon candidates 68 as the selected coupon text 74. By deduplicating the coupon candidates 68, a diverse set of selected coupon text 74 are presented to the user 704.

The selected coupon text 74 may be based on textual matching and/or embeddings to pick the best consumable coupons for the users 704 to match with the query 66. An example use case includes the user 704 entering a query 66 for “a specific product of chew toys” and two coupon candidates 68 are returned “$5 off on the particular product of chew toys” and “$5 off on chew toys.” The browser 62 selects the coupon candidate 68 “$5 off on the particular product of chew toys” as the selected coupon text 74 to present on the website 64 since the selected coupon text 74 matches the product searched for in the search query 66.

The selected coupon text 74 are presented on the website 64 in response to the query 66. In an implementation, the selected coupon text 74 are presented in a cascading waterfall that the user 704 may scroll through and see different coupons from the selected coupon text 74. Moreover, the selected coupon text 74 provide contextual text related to the query 66. The contextual text helps the users 704 quickly navigate through the selected coupon text 74 and consume the coupons better.

An example use case includes the user 704 entering in a query 66 for a specific brand of laptops. The coupon candidates 68 returned for the query 66 include the original coupon text 15 for a coupon 12 “$50 off on electronics at a merchant's website” and a generated coupon text 28 for the coupon 12 “$50 off on the specific brand of laptops at a merchant's website.” The browser 62 selects the coupon candidate 68 with the generated coupon text 28 for the coupon 12 “$50 off on the specific brand of laptops at a merchant's website” as the selected coupon text 74 to present on the website 64. Thus, instead of having a general coupon text 15 presented in response to the query 66, the user 704 receives the generated coupon text 28 with the specific brand that the user 704 is searching for in the query 66.

In some implementations, the browser 62 interacts with an application 76 that publishes coupons and receives the selected coupon text 74 from the application 76 for presentation on the websites 64. The application 76 may access the coupon catalogs 17 and may identify the trending product classes across the web using queries and/or product sales. The application 76 uses browser logs 40 (FIG. 5) to identify the product classes with more impression counts (e.g., the product classes that are more popular with the users 704). The application 76 may generate the coupon candidates 68 based on the trending product classes from the impression counts from the browser logs 40.

The application 76 may perform the ranking 70 and deduplication 72 of the coupon candidates 68 and select coupon text 74 to publish to various content platforms. For example, the selected coupon text 74 are published to the browser 62 for presentation on the websites 64. An example use case includes the user 704 browsing different categories of products or merchants and the browser 62 presenting the selected coupon text 74 (e.g., the top ten coupons) for the product class or merchants that the user 704 is currently browsing. As such, the application 76 may publish for every category in the product class, selected coupon text 74 for the user 704 to consume.

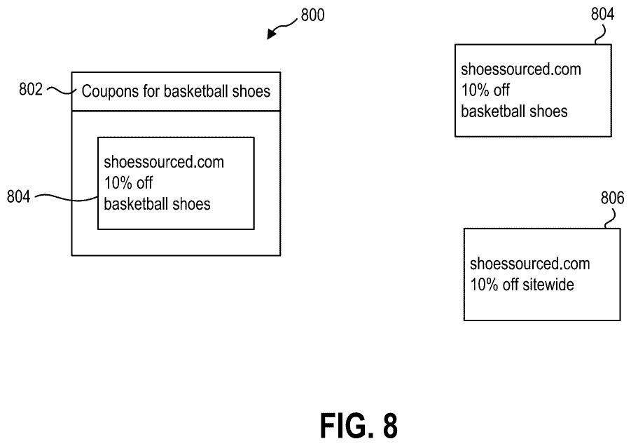

Referring now to FIG. 8, illustrated is an example GUI 800 for a website 64 (FIG. 7) when a user 704 (FIG. 7) performs a search query 802 for “coupons for basketball shoes.” The browser 62 (FIG. 7) may receive two coupons 804, 806 as coupon candidates 68 (FIG. 7). The coupon 804 is for “10% off basketball shoes” at shoessourced.com and the coupon 806 is for “10% off sitewide” at shoessourced.com. The coupon 806 has the original coupon text 15 for the sitewide discount at shoessourced.com and the coupon 804 has a generated coupon text 28 with a product class (basketball shoes) that is sold at shoessourced.com. The browser 62 selects the coupon 804 to present on the website 64 in response to the search query 802 based on the generated coupon text 28 matching the text of the search query 802. The coupon 804 is presented to the user 704 in response to the query 802 and the coupon 804 provides a contextual text with the product searched for by the user 704. The contextual text in the coupon 804 may help the user 704 easily identify that the coupon 804 is relevant to the search terms in the query 802.

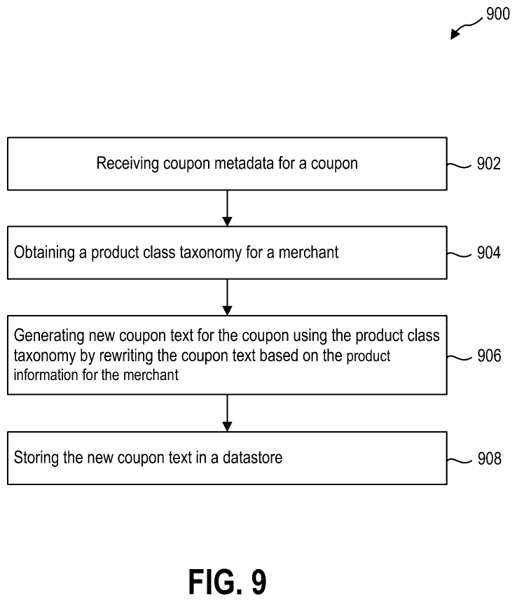

Referring now to FIG. 9, illustrated is an example method 900 for automatically generating coupon text. The actions of the method 900 are discussed below with reference to the architectures of FIGS. 3-7.

At 902, the method 900 includes receiving coupon metadata for a coupon. The generative model 314 receives the coupon metadata 14 for the coupons 12. The coupon metadata 14 identifies a merchant 16 for the coupon 12 and a coupon text 15 for the coupon 12. The coupon metadata 14 may also identify brand information, a product name, and/or constraints for the coupon 12. In some implementations, a coupon processing model 402 pre-processes the coupons 12 to identify the coupon metadata 14 and the coupon metadata 14 is obtained by a coupon metadata extractor 302.

At 904, the method 900 includes obtaining a product class taxonomy for the merchant. The product class taxonomy 22 identifies product information for the merchant 16. The product information includes one or more of product classes 50, brands 48, product 46 names, or price information 52. The product class taxonomy 22 provides a product hierarchy of the different products 46 that the merchant 16 provides or sells. The product class taxonomy 22 may include different product classes 50 and subcategories of products within the different product classes 50. The product class taxonomy 22 provides a hierarchical chain of the different products 46 that the merchant 16 provides with the product class 50 at the root of the chain with the subcategories at a next level followed by the different products 46 and/or brands 48 of products 46.

At 906, the method 900 includes generating new coupon text for the coupon using the product class taxonomy by rewriting the coupon text based on the product information for the merchant. The generative model 314 generates new coupon text 26 for the coupon 12 using the product class taxonomy 22 by rewriting the coupon text 15 based on the product information from the product class taxonomy 22 for the merchant 16.

In some implementations, generating the new coupon text 26 includes the generative model 314 selecting a regex pattern 58 with a plurality of placeholders and dynamically filling each placeholder of the plurality of placeholders with the coupon metadata 14 and the product information from the product class taxonomy 22. The placeholders are for the different portions of the new coupon text 26. An example of the placeholders include a savings quantifier placeholder, a constraints placeholder, a product class placeholder, and a product placeholder. The generative model 314 may add information from the coupon metadata 14 or the product information that matches the placeholders of the regex pattern 58. For example, if the placeholder is a savings quantifier for the coupon 12, the generative model 314 fills in the saving quantifier information from the coupon metadata 14 (e.g., $10 off). If the placeholder is a product name, the generative model 314 fills in a product 46 name from the product class taxonomy 22 for the merchant 16. The generative model 314 may associate the new coupon text 26 with a filled regex pattern 58.

In some implementations, the regex pattern 58 is a top down regex pattern 54 that is selected based on identifying the coupon 12 as a sitewide coupon 32 based on the coupon metadata 14. The sitewide coupons 32 are not specific to a brand or category of product and are applicable across the merchant's websites. An example of the placeholders for the top down regex pattern 58 include one or more of a savings quantifier, a product class, a product, a brand, a constraint of the coupon, or the merchant.

In some implementations, the regex pattern 58 is a bottom up regex pattern 56 that is selected based on identifying the coupon 12 as a non-sitewide coupon 34 based on the coupon metadata 14. The non-sitewide coupons 34 are applicable to a certain categories, brands, or products. An example of the placeholders for the bottom up regex pattern 56 include one or more of a savings quantifier, a product class, a constraint of the coupon, or the merchant.

In some implementations, one or more machine learning models 60 determine a plurality of regex patterns 58 to write based on a combination of the product classes, brands, product names, or price information included in the product information for the merchant. The machine learning models dynamically fill each placeholder of the plurality of placeholders for each of the regex patterns 58 with the product information from the product class taxonomy 22 or the coupon metadata 14.

The generative model 314 expands the original coupon text 15 for the coupon 12 to the various combinations of product classes 20 and/or brands 18 identified for the merchant 16. In some implementations, the generative model 314 generates hundreds of different new coupon text 26 for the coupon 12. The new coupon text 26 may have different hierarchical levels based on the product class taxonomy 22 identified for the merchant 16.

At 908, the method 900 includes storing the new coupon text in a datastore. The generative model 314 may store the new coupon text 26 in the coupon catalogs 17 databases in the datastores 320, 318. As such, the method 900 may be used to expand the coupon catalogs 17 with different variations for the same coupon 12 by providing a plurality of new coupon text 26 with different products, product classes, and/or brands for the same coupon 12.

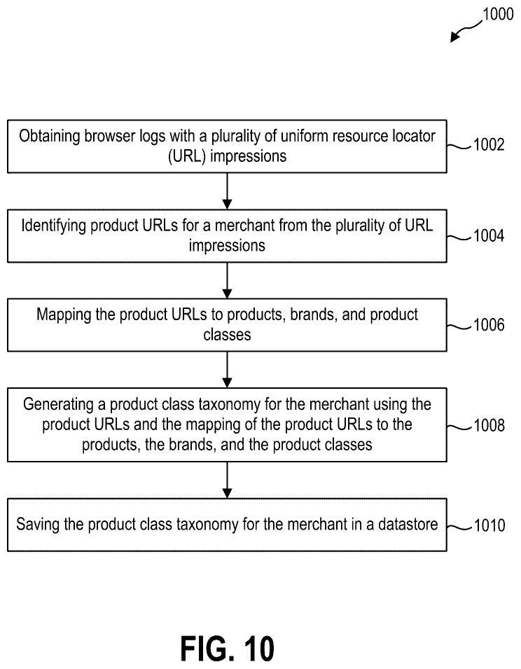

Referring now to FIG. 10, illustrated is an example method 1000 for creating product class taxonomies for merchants. The actions of the method 1000 are discussed below with reference to the architectures of FIGS. 3-7.

At 1002, the method 1000 includes obtaining browser logs with a plurality of uniform resource locator impressions. A page classifier 502 obtains the browser logs 40 with the uniform resource locator (URL) impressions 42 of the different websites visited by one or more users interacting with one or more browsers. In some implementations, the page classifier obtains the browser logs 40 within a timeframe on a regular basis (e.g., the past week, the past month, the past six months, etc.).

At 1004, the method 1000 includes identifying the product URLs for a merchant from the plurality of URL impressions. The product page classifier 502 mines all the URL impressions 42 viewed by the users and identifies the product URLs 44 for different merchants 16 from the URL impressions 42. The product page classifier 502 uses the browser logs 40 to identify the different products viewed by users when interacting with the browsers and to classify the product page URLs 44. In some implementations, one or more machine learning models 506 identify the product URLs 44 for the merchant 16 from the plurality of URL impressions 42.

At 1006, the method 1000 includes mapping the product URLs to products, brands, or product classes. The machine learning models 506 map the product URLs 44 to different products 46, brands 48 and product classes 50. The machine learning models 506 extract information from the different product websites to identify the products 46, the brands 48, and/or the product classes 50 from the websites associated with the product URLs 44.

The machine learning models 506 use the product URLs 44 to extract additional information. For each product URL 44, the product page classifier 502 extracts the product 46 title, the price information 52, an image, a description of the product, and/or the brand 48 information. In some implementations, the price information 52 includes an average price for the products 46 and/or the brands 48. In some implementations, the price information 52 includes a minimum price and/or a maximum price for the products 46 and/or the brands 48. In addition, the machine learning models 506 classify the products 46 to a specific product class 50 category.

At 1008, the method 1000 includes generating a product class taxonomy for the merchant using the product URLs and the mapping of the product URLs to the products, the brands, and the product classes. A taxonomy model 504 generates the product class taxonomy 22 for the merchant 16 using the product URLs 44 and the product class 50, brands 48, and product 46 information extracted from the product URLs 44. The taxonomy model 504 may generate the product class taxonomy 22 for each merchant 16 in the browser logs 40.

The product class taxonomy 22 provides a hierarchy of the product classes, the brands, and the products. The product class taxonomy 22 provides a hierarchical chain of the different product classes 50, the brands 48, and the different products 46 that the merchant 16 provides with the product class 50 at the root of the chain with the brands 48 and/or subcategories of products at a next level followed by the different products 46.

The product class taxonomy 22 may also include price information 52 for the products 46 included in the product class taxonomy 22. In some implementations, the price information 52 is the average price of the products 46 included in the product class taxonomy 22. In some implementations, the price information 52 is a minimum price of the products 46 included in the product class taxonomy 22 and/or a maximum price of the products 46 included in the product class taxonomy 22.

The taxonomy model 504 may dynamically create the product class taxonomy 22 for the merchant 16 based on the URL impressions 42 within a selected timeframe. For example, the selected time frame is the past three months. In some implementations, the product classes 50, the brands 48, and the products 46 are included in the product class taxonomy 22 based on an impression count for the product URLs 44 exceeding a threshold value. As such, popular products 46 and brands 48 (products and brands where the impression counts indicate more users viewed the products and brands) may be included in the product class taxonomy 22 instead of less popular products (products and brands where the impression counts indicate fewer users viewed the products and brands).

In some implementations, the taxonomy model 504 normalizes different names for the same brand 48 into a single name for the brand 48 to reduce duplicative names for the same brand included in the product class taxonomy 22. For example, the brand “Microsoft” and “Microsoft Inc.” is mapped to the brand “Microsoft” so that one single entry is included in the product class taxonomy 22 for the brand instead of two entries.

At 1010, the method 1000 includes saving the product class taxonomy for the merchant in a datastore. The taxonomy model 504 may save the product class taxonomy 22 in the datastore 312.

The method 1000 dynamically creates the product class taxonomy 22 for any merchant 16 using browser logs 40. The product class taxonomy 22 provides a granular mapping of the average prices, a minimum price, and a maximum price for all the products 46 sold by the merchant 16.

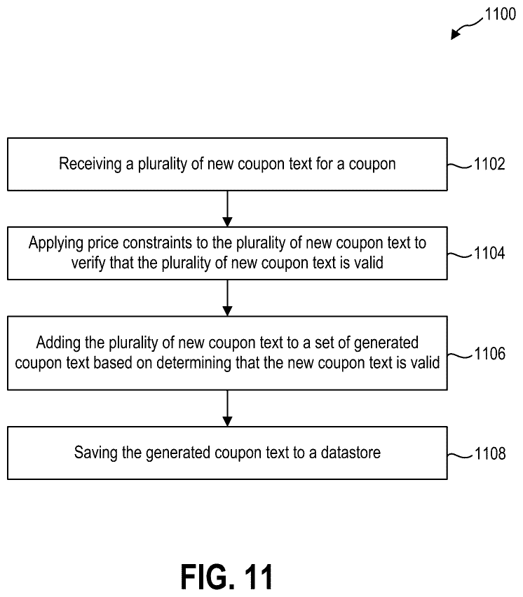

Referring now to FIG. 11, illustrated is an example method 1100 for processing new coupon text for coupons. The actions of the method 1100 are discussed below with reference to the architectures of FIGS. 3-7.

At 1102, the method 1100 includes receiving a plurality of new coupon text for a coupon. A post processing model 316 may receive the plurality of new coupon text 26 from the generative model 314. The plurality of new coupon text 26 may include all the different variations of the products, product classes, and/or brands created for the coupon 12. The plurality of new coupon text 26 may include several hundred different variations for the same coupon 12.

At 1104, the method 1100 includes applying price constraints to the plurality of new coupon text to verify that the plurality of new coupon text is valid. A post processing model 316 may perform one or more pruning steps on the new coupon text 26 to reduce the new coupon text 26 to a subset of generated coupon text 28. The pruning steps may remove incorrect coupon text from the new coupon text 26. In addition, the pruning steps may verify that the new coupon text 26 is applicable to the products.

The post processing model 316 applies price constraints based on the average prices, the minimum prices, and/or the maximum prices of the products for the merchant 16 using the information from the product class taxonomy 22 for the merchant 16 to ensure that the new coupon text 26 is applicable to the products. In some implementations, the post processing model 316 applies the new coupon text 26 on a sample set of products for the merchant 16.

At 1106, the method 1100 includes adding the plurality of new coupon text to a set of generated coupon text based on determining that the new coupon text is valid. If the new coupon text 26 is valid, the new coupon text 26 is added to the generated coupon text 28 subset. If the new coupon text 26 is not valid, the new coupon text 26 is not added to the generated coupon text 28 subset.

In some implementations, verifying that the new coupon text is valid includes the post processing model 316 comparing the price information of a product or brand of products included in a new coupon text 26 of the plurality of coupon text to a savings quantifier of the coupon 12. The new coupon text 26 is valid if the price information indicates that the savings quantifier applies to the product or brand of products. The new coupon text 26 is not valid if the price information indicates that savings quantifier does not apply to the product or brand of products.

In some implementations, the post processing model 316 verifies that the new coupon text 26 is valid by receiving information that the coupon 12 is valid for a product 24. The information is received from browser logs 40 that identify coupon tags users clicked on when searching for products. As such, the browser logs 40 identifies if a particular coupon 12 is applied to a specific type of product and whether the coupon works for the specific type of product. If the post processing model 316 determines that the new coupon text 26 includes the product 24 or product class 20, the post processing model 316 may verify that new coupon text 26 is valid. As such, the information may be used by the post processing model 316 to avoid a large number of restrictions and prune out incorrect new coupon text 26 based on the information.

At 1108, the method 1100 includes saving the generated coupon text to a datastore. The post processing model 316 saves the generated coupon text 28 in one or more datastores 320, 318. The generated coupon text 28 is added to the coupon catalogs 17 databases and associated with the original coupon 12. Thus, instead of having one coupon title or coupon text 15 for the coupon 12, the coupon catalog 17 has a plurality of generated coupon titles or generated coupon text 28 for the coupon 12. The generated coupon text 28 may provide more contextual information for the coupon 12 by adding in specific product names 24, product classes 20, and/or brands 18. Different applications (e.g., coupon publishing platforms) or search engines may obtain the generated coupon text 28 from the coupon catalogs 17 and present the generated coupon text 28 on a website. As such, the generated coupon text 28 is presented by a browser 62 on a website 64 in response to a query 66.

The method 1100 may be used to remove the new coupon text 26 that is incorrect or not applicable to the products and may reduce the generated coupon text 28 to valid coupons for the products. The verification of the new coupon text 26 prevents misrepresentations of the generated coupon text 28 for the products.

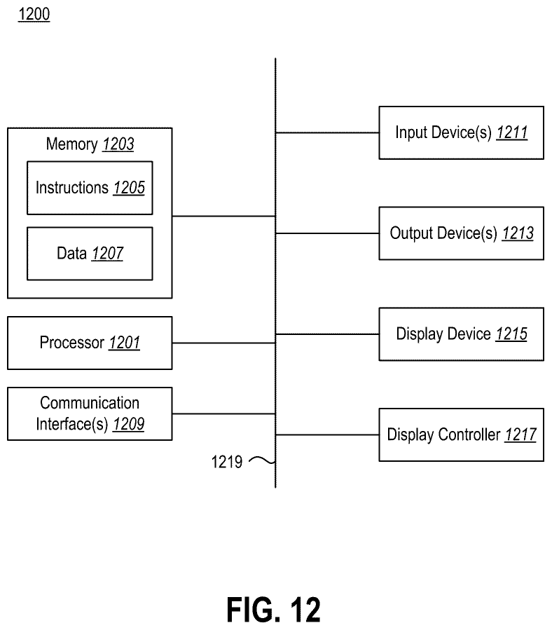

FIG. 12 illustrates certain components that can be included within a computing system 1200 that can be used to implement the actions and operations described herein. In some embodiments, a plurality of computing systems 1200 can collectively implement the actions and operations described herein.

The computing system 1200 includes a processor 1201 and memory 1203 in electronic communication with the processor 1201. Instructions 1205 and data 1207 can be stored in the memory 1203. The instructions 1205 can be executable by the processor 1201 to implement some or all of the methods, steps, operations, actions, or other functionality disclosed herein. Executing the instructions 1205 can involve the use of the data 1207 that is stored in the memory 1203. When the processor 1201 executes the instructions 1205, various instructions 1205 can be loaded onto the processor 1201, and various pieces of data 1207 can be loaded onto the processor 1201.

Unless otherwise specified, any of the various examples of modules and components described herein can be implemented, partially or wholly, as instructions 1205 stored in memory 1203 and executed by the processor 1201. Any of the various examples of data described herein can be among the data 1207 that is stored in memory 1203 and used during execution of the instructions 1205 by the processor 1201.

Although just a single processor 1201 and a single memory 1203 are shown in the computing system 1200 of FIG. 12, in an alternative configuration, a combination of processors and/or a combination of memory devices could be used.

The instructions 1205 in the memory 1203 can be executable by the processor 1201 to perform some or all aspects of the methods that have been described herein. The data 1207 stored in the memory 1203 can include any of the various examples of data described herein, including any data that is stored, accessed, or otherwise used in connection with the methods that have been described herein.

The computing system 1200 may also include various other components, including one or more communication interfaces 1209, one or more input devices 1211, and one or more output devices 1213.

The communication interface(s) 1209 can be configured to communicate with other computing systems and/or networking devices. This includes receiving data transmissions from other computing systems and/or networking devices, and also sending data transmissions to other computing systems and/or networking devices. The communication interface(s) 1209 can be based on wired communication technology, wireless communication technology, or both. Some examples of communication interfaces 1209 include a Universal Serial Bus (USB), an Ethernet adapter, a wireless adapter that operates in accordance with an Institute of Electrical and Electronics Engineers (IEEE) 802.11 wireless communication protocol, a Bluetooth® wireless communication adapter, and an infrared (IR) communication port.

The various components of the computing system 1200 can be coupled together by one or more buses, which can include a power bus, a control signal bus, a status signal bus, a data bus, etc. For simplicity, the various buses are illustrated in FIG. 12 as a bus system 1219.

As illustrated in the foregoing discussion, the present disclosure utilizes a variety of terms to describe features and advantages of the model evaluation system. Additional detail is now provided regarding the meaning of such terms. For example, as used herein, a “machine learning model” refers to a computer algorithm or model (e.g., a classification model, a binary model, a regression model, a language model, an object detection model) that can be tuned (e.g., trained) based on training input to approximate unknown functions. For example, a machine learning model may refer to a neural network (e.g., a convolutional neural network (CNN), deep neural network (DNN), recurrent neural network (RNN)), or other machine learning algorithm or architecture that learns and approximates complex functions and generates outputs based on a plurality of inputs provided to the machine learning model. As used herein, a “machine learning system” may refer to one or multiple machine learning models that cooperatively generate one or more outputs based on corresponding inputs. For example, a machine learning system may refer to any system architecture having multiple discrete machine learning components that consider different kinds of information or inputs.

The techniques described herein may be implemented in hardware, software, firmware, or any combination thereof, unless specifically described as being implemented in a specific manner. Any features described as modules, components, or the like may also be implemented together in an integrated logic device or separately as discrete but interoperable logic devices. If implemented in software, the techniques may be realized at least in part by a non-transitory processor-readable storage medium comprising instructions that, when executed by at least one processor, perform one or more of the methods described herein. The instructions may be organized into routines, programs, objects, components, data structures, etc., which may perform particular tasks and/or implement particular data types, and which may be combined or distributed as desired in various implementations.

Computer-readable mediums may be any available media that can be accessed by a general purpose or special purpose computer system. Computer-readable mediums that store computer-executable instructions are non-transitory computer-readable storage media (devices). Computer-readable mediums that carry computer-executable instructions are transmission media. Thus, by way of example, and not limitation, implementations of the disclosure can comprise at least two distinctly different kinds of computer-readable mediums: non-transitory computer-readable storage media (devices) and transmission media.

As used herein, non-transitory computer-readable storage mediums (devices) may include RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

The steps and/or actions of the methods described herein may be interchanged with one another without departing from the scope of the claims. In other words, unless a specific order of steps or actions is required for proper operation of the method that is being described, the order and/or use of specific steps and/or actions may be modified without departing from the scope of the claims.

The articles “a,” “an,” and “the” are intended to mean that there are one or more of the elements in the preceding descriptions. The terms “comprising,” “including,” and “having” are intended to be inclusive and mean that there may be additional elements other than the listed elements. Additionally, it should be understood that references to “one implementation” or “an implementation” of the present disclosure are not intended to be interpreted as excluding the existence of additional implementations that also incorporate the recited features. For example, any element described in relation to an implementation herein may be combinable with any element of any other implementation described herein. Numbers, percentages, ratios, or other values stated herein are intended to include that value, and also other values that are “about” or “approximately” the stated value, as would be appreciated by one of ordinary skill in the art encompassed by implementations of the present disclosure. A stated value should therefore be interpreted broadly enough to encompass values that are at least close enough to the stated value to perform a desired function or achieve a desired result. The stated values include at least the variation to be expected in a suitable manufacturing or production process, and may include values that are within 5%, within 1%, within 0.1%, or within 0.01% of a stated value.

A person having ordinary skill in the art would realize in view of the present disclosure that equivalent constructions do not depart from the spirit and scope of the present disclosure, and that various changes, substitutions, and alterations may be made to implementations disclosed herein without departing from the spirit and scope of the present disclosure. Equivalent constructions, including functional “means-plus-function” clauses are intended to cover the structures described herein as performing the recited function, including both structural equivalents that operate in the same manner, and equivalent structures that provide the same function. It is the express intention of the applicant not to invoke means-plus-function or other functional claiming for any claim except for those in which the words ‘means for’ appear together with an associated function. Each addition, deletion, and modification to the implementations that falls within the meaning and scope of the claims is to be embraced by the claims.

### INDUSTRIAL APPLICABILITY

The present disclosure relates to an unsupervised coupon text generation system that generates different text for existing coupons. The text includes coupon titles, descriptions included in the coupon, information included in the coupon, and/or a body of the coupon. The systems and methods automatically expands the coupon-catalogs using a product class taxonomy hierarchy for merchants that identifies the different products, brands, or product classes for the merchant. A product class taxonomy is created for the merchants in an unsupervised manner, allowing for matching the site-wide coupons to particular products of the merchants. The product class taxonomy is dynamically created for the merchants based on the browser logs of URL impressions for the product URLs of the merchant. The product class taxonomy provides the product hierarchy chain for the merchant to a granular level for each product class, subcategories of products, brands of products, and product names provided by the merchant.

The systems and methods create a plurality of new coupon text for a coupon provided by a merchant based on the product class taxonomy for the merchant. The text of the coupon (e.g., the coupon title) is rewritten to apply to the different products, brands, and product classes provided by the merchant. In some implementations, the new coupon text includes new coupon titles, new coupon bodies, and/or new descriptions.

The coupons may be ranked, and the top results may be returned to users. In some implementations, a browser presents the top results of the ranked coupons to the users in response to a query. As such, when a user is searching for a product, the text of the coupon may be rewritten so that the new coupon text (e.g., a new coupon title) applies to the product included in the search query. In some implementations, a browser presents the top results of the ranked coupons on a website that the user is viewing. In some implementations, a coupon publishing application provides the top results of the ranked coupons for use by different applications or browsers.

The present disclosure automatically expands the coupon-catalogs using a taxonomy hierarchy for the merchants by generating different text for existing coupons. The auto-expansion of the coupon catalogs is useful in semi-automated coupon article generation as well as in ranking the coupons.

One technical advantage of the present disclosure is a runtime advantage as the system and methods identify applicable coupon codes and presents the applicable coupon codes to the user for selection when the user provides a query or accesses a webpage. Thus, instead of having the user open a new browser window or tab to search for coupons, the systems and methods automatically identifies the applicable coupon codes and presents the applicable coupon codes to the user for selection. Moreover, the systems and methods provide relevant coupons tailored towards the user's context, which helps the users to quickly navigate through the coupons and better consume the coupons.

(A1) Some implementations include a method for automatically generating coupon text. The method includes receiving (902) coupon metadata (e.g., coupon metadata 14) for a coupon (e.g., coupon 12), wherein the coupon metadata identifies a merchant (e.g., merchant 16) for the coupon and a coupon text (e.g., coupon text 15) for the coupon. The method includes obtaining (904) a product class taxonomy (e.g., product class taxonomy 22) for the merchant, wherein the product class taxonomy identifies product information for the merchant. The method includes generating (906) new coupon text (e.g., new coupon text 26) for the coupon using the product class taxonomy by rewriting the coupon text based on the product information for the merchant. The method includes storing (910) the new coupon text in a datastore (e.g., datastores 320, 318).

(A2) In some implementations of the method of A1, the product information includes one or more of product classes, brands, product names, or price information.

(A3) In some implementations of the method of A1 or A2, generating the new coupon text includes selecting a regex pattern (e.g., regex pattern 58) with a plurality of placeholders; dynamically filling each placeholder of the plurality of placeholders with the coupon metadata and the product information from the product class taxonomy by matching the coupon metadata and the product information to a corresponding placeholder; and associating the new coupon text with a filled regex pattern.

(A4) In some implementations of the method of any of A1-A3, the regex pattern is a top down regex pattern (e.g., top down regex pattern 54) that is selected based on identifying the coupon as a sitewide coupon using the coupon metadata; and the plurality of placeholders for the top down regex pattern include one or more of a savings quantifier, a product class, a product, a brand, a constraint of the coupon, or the merchant.

(A5) In some implementations of the method of any of A1-A4, the regex pattern is a bottom up regex pattern (e.g., bottom up regex pattern 56) that is selected based on identifying the coupon as a non-sitewide coupon using the coupon metadata; and the plurality of placeholders for the bottom up regex pattern include one or more of a savings quantifier, a product class, a constraint of the coupon, or the merchant.

(A6) In some implementations of the method of any of A1-A5, generating the new coupon text is performed by one or more machine learning models (e.g., machine learning models 60) determining a plurality of regex patterns to write based on a combination of product classes, brands, product names, or price information included in the product information for the merchant; and the one or more machine learning models dynamically filling the plurality of placeholders for each regex pattern of the plurality of regex patterns with the product information from the product class taxonomy or the coupon metadata.

(A7) In some implementations of the method of any of A1-A6, the new coupon text expand a coupon catalog (e.g., coupon catalog 14) with different variations for the coupon.

(A8) In some implementations, the method of any of A1-A7 includes receiving a query for coupons for a product; obtaining, from the datastore, the new coupon text for one or more coupons associated with the product; and causing the new coupon text for the one or more coupons to be presented in response to the query.

(B1) Some implementations include a method for creating product class taxonomies for merchants. The method includes obtaining (1002) browser logs (e.g., browser logs 40) with a plurality of uniform resource locator (URL) impressions (e.g., URL impressions 42). The method includes identifying (1004) product URLs (e.g., product URLs 44) for a merchant (e.g., merchant 16) from the plurality of URL impressions. The method includes mapping (1006) the product URLs to products (e.g., products 46), brands (e.g., brands 48), and product classes (e.g., product classes 50). The method includes generating (1010) a product class taxonomy (e.g., product class taxonomy 22) for the merchant using the product URLs and the mapping of the product URLs to the products, the brands, and the product classes, wherein the product class taxonomy provides a hierarchy of the product classes, the brands, and the products. The method includes saving (1012) the product class taxonomy for the merchant in a datastore (e.g., datastore 312).

(B2) In some implementations of the method of B1, the product class taxonomy is dynamically created for the merchant based on the URL impressions within a selected timeframe.

(B3) In some implementations of the method of B1 or B2, the product classes, the brands, and the products are included in the product class taxonomy based on an impression count for the product URLs exceeding a threshold value.

(B4) In some implementations, the method of B1-B3 includes normalizing the brands to reduce duplicative names for a same brand included in the product class taxonomy.

(B5) In some implementations of the method of any of B1-B4, the product class taxonomy further includes price information (e.g., price information 52) for the products included in the product class taxonomy.

(B6) In some implementations of the method of any of B1-B5, the price information is an average price of the products included in the product class taxonomy.

(B7) In some implementations of the method of any of B1-B6, the price information is a minimum price and a maximum price of the products included in the product class taxonomy.

(B8) In some implementations of the method of any of B1-B7, one or more machine learning models identify the product URLs for the merchant and map the product URLs to products, the brands, and the product classes.

(B9) In some implementations of the method of any of B1-B8, the product class taxonomy is created for each merchant in the browser logs.

(C1) Some implementations include a method for processing new coupon text for a coupon. The method includes receiving (1102) a plurality of new coupon text (e.g., new coupon text 26) for a coupon (e.g., coupon 12). The method includes applying (1104) price constraints to the plurality of new coupon text to verify that the plurality of new coupon text is valid. The method includes adding (1106) the plurality of new coupon text to a set of generated coupon text (e.g., generated coupon text 28) based on determining that the new coupon text is valid. The method includes saving (1108) the generated coupon text to a datastore (e.g., datastores 320, 318).

(C2) In some implementations of the method of C1, verifying that the plurality of new coupon text is valid includes: comparing price information of a product or brand of products included in a new coupon text to a savings quantifier of the coupon; determining that the new coupon text is valid if the price information indicates that the savings quantifier applies to the product or brand of products; and determining that the new coupon text is not valid if the price information indicates that savings quantifier does not apply to the product or brand of products.

(C3) In some implementations, the method of C1 or C2 includes receiving information that the coupon is valid for a product; and determining that the new coupon text is valid based on the new coupon text including the product.

(C4) In some implementations, the method of C1-C3 includes ranking the generated coupon text, wherein a portion of the generated coupon text is presented by a browser (e.g., browser 62) on a website (e.g., website 64) based on the ranking (e.g., ranking 70) in response to a query (e.g., query 66).

Some implementations include a system (e.g., environment 300, environment 500). The system includes one or more processors; memory in electronic communication with the one or more processors; and instructions stored in the memory, the instructions being executable by the one or more processors to perform any of the methods described here (e.g., A1-A8, B1-B9, C1-C4).

Some implementations include a computer-readable storage medium (e.g., memory 1203) storing instructions executable by one or more processors (e.g., processor 1201) to perform any of the methods described here (e.g., A1-A8, B1-B9, C1-C4).

The present disclosure may be embodied in other specific forms without departing from its spirit or characteristics. The described implementations are to be considered as illustrative and not restrictive. The scope of the disclosure is, therefore, indicated by the appended claims rather than by the foregoing description. Changes that come within the meaning and range of equivalency of the claims are to be embraced within their scope.

What is claimed is:

1. A method for creating product class taxonomies for merchants, comprising:
obtaining browser logs with a plurality of uniform resource locator (URL) impressions;
identifying product URLs for a merchant from the plurality of URL impressions;
mapping the product URLs to products, brands, and product classes;
generating a product class taxonomy for the merchant using the product URLs and the mapping of the product URLs to the products, the brands, and the product classes, wherein the product class taxonomy provides a hierarchy of the product classes, the brands, and the products; and
saving the product class taxonomy for the merchant in a datastore.

2. The method of claim 1, further comprising:
generating a plurality of new coupon text for a coupon for the merchant, the generating including dynamically filling each place holder of a regex pattern having different placeholders corresponding to different parts of the coupon to be filled with additional textual descriptions obtained using the product class taxonomy;
applying price constraints to the plurality of new coupon text to verify that the plurality of new coupon text is valid;
adding the plurality of new coupon text to a set of generated coupon text in response to determining that the plurality of new coupon text is valid; and
saving the set of generated coupon text to a datastore.

3. The method of claim 2, wherein verifying that the plurality of new coupon text is valid includes:
comparing price information of a product or brand of products included in a new coupon text to a savings quantifier of the coupon;
determining that the new coupon text is valid if the price information indicates that the savings quantifier applies to the product or brand of products; and
determining that the new coupon text is not valid if the price information indicates that savings quantifier does not apply to the product or brand of products.

4. The method of claim 2, further comprising:
receiving information that the coupon is valid for a product; and
determining that a new coupon text is valid in response to the new coupon text including the product.

5. The method of claim 2, further comprising:
ranking the set of generated coupon text, wherein a portion of the set of generated coupon text is presented by a browser on a website based on the ranking in response to a query.

6. The method of claim 1, wherein the product class taxonomy is dynamically created for the merchant using the URL impressions from within a selected timeframe.

7. The method of claim 1, wherein the product classes, the brands, and the products are included in the product class taxonomy in response to an impression count for the product URLs exceeding a threshold value.

8. The method of claim 1, further comprising:
normalizing the brands to reduce duplicative names for a same brand included in the product class taxonomy.

9. The method of claim 1, wherein the product class taxonomy further includes price information for the products included in the product class taxonomy.

10. The method of claim 9, wherein the price information is an average price of the products, a minimum price of the products, and a maximum price of the products.

11. The method of claim 1, wherein one or more machine learning models identify the product URLs for the merchant and map the product URLs to products, the brands, and the product classes.

12. The method of claim 1, wherein the product class taxonomy is created for each merchant in the browser logs.

13. A system comprising:
a memory to store data and computer program instructions; and
a processor operable to communicate with the memory and to execute the computer program instructions to cause the processor to:
obtain browser logs with a plurality of uniform resource locator (URL) impressions;
identify product URLs for a merchant from the plurality of URL impressions;
map the product URLs to products, brands, and product classes; and
save the product class taxonomy for the merchant in a datastore.

14. The system of claim 13, wherein the computer program instructions to cause the processor to:
generate a plurality of new coupon text for a coupon for the merchant, the generating including dynamically filling each place holder of a regex pattern having different placeholders corresponding to different parts of the coupon to be filled with additional textual descriptions obtained using the product class taxonomy;
apply price constraints to the plurality of new coupon text to verify that the plurality of new coupon text is valid;
add the plurality of new coupon text to a set of generated coupon text in response to determining that the plurality of new coupon text is valid; and
save the set of generated coupon text to a datastore.

15. The system of claim 14, wherein the processor verifies that the plurality of new coupon text is valid by:
comparing price information of a product or brand of products included in a new coupon text to a savings quantifier of the coupon;
determining that the new coupon text is valid if the price information indicates that the savings quantifier applies to the product or brand of products; and
determining that the new coupon text is not valid if the price information indicates that savings quantifier does not apply to the product or brand of products.

16. The system of claim 14, wherein the computer program instructions further cause the processor to:
receive information that the coupon is valid for a product; and
determine that a new coupon text is valid in response to the new coupon text including the product.

17. The system of claim 14, wherein the computer program instructions further cause the processor to:
rank the set of generated coupon text, wherein a portion of the set of generated coupon text is presented by a browser on a website based on the ranking in response to a query.

18. The system of claim 13, wherein the product class taxonomy is dynamically created for the merchant using the URL impressions from within a selected timeframe.

19. The system of claim 13, wherein the product classes, the brands, and the products are included in the product class taxonomy in response to an impression count for the product URLs exceeding a threshold value.

20. The system of claim 13, wherein one or more machine learning models identify the product URLs for the merchant and map the product URLs to products, the brands, and the product classes.
